(19) United States
(12) Patent Application Publication
(10) Pub. No.: US 2003/0088493 A1
(43) Pub. Date: May 8, 2003

(54) Business case system

(76) Inventors: John Scott Larsen, Odenton, MD (US); Justin Prichard Parke, Washington, DC (US)

Correspondence Address: Ivan Mlachak, Lewis & Roca, LLP, 40 N. Central Ave., Phoenix, AZ, 85004, US

(21) Appl. No.: 10/281,477

(22) Filed: Oct. 24, 2002

Related U.S. Application Data
(60) Provisional application No. 60/345,068, filed on Oct. 24, 2001.

(51) Int. Cl. G06F 17/60

(52) U.S. Cl. 705/36; 705/38; 705/35

(57) ABSTRACT

A system and method is provided for preparing, submitting, and evaluating a business case. The method comprises steps of inputting data into a software application including administrative data about the prospective investment, selected data on capital and expense funds, financial benefits to be gained from the investment, the degree of strategic alignment related to the investment; the degree of impact of an investment opportunity, risk level, and milestones. The plan is then submitted for peer review and comment. The business case may be revised. Business opportunities are then prioritized for investment based on quantified values of data.

### CROSS-REFERENCE TO RELATED APPLICATIONS

This application claims priority from U.S. Provisional Application No. 60/345,068 filed on Oct. 24, 2001, entitled “Business Case System.” The contents of the above provisional application is relied upon and expressly incorporated by reference as if fully set forth herein.

### STATEMENT REGARDING FEDERALLY SPONSORED RESEARCH OR DEVELOPMENT

The invention was made by an agency of the United States government or under a contract with an agency of the United States government, the United States Postal Service (“USPS” or “Postal Service”), an independent establishment of the executive branch of the U.S. government.

### BACKGROUND OF THE INVENTION

1. Field of the Invention

The present invention relates to the field of business solutions development. More particularly the invention relates to the provision of a process methodology for an automated system and program product for evaluating particular aspects of a business enterprise and business-related requirements of the enterprise. The invention further relates to a business solution deliverable based on strategic alignment, financial values, qualitative value, and risk analysis.

2. Description of the Related Art

The proliferation of information processing solutions available to a business enterprise has proven advantageous to most modern enterprises. Information processing provides an opportunity to apply the benefits of computer processing technology to many areas of the enterprise and accordingly allows a business to make better business decisions.

Many organizations must face business decisions on a periodic basis. The decisions may relate to the justification of an investment related to an aspect of the business. Oftentimes, such business decisions are repetitive in nature. Further, in large organizations, both private and governmental, a variety of functional groupings within the organization may be called upon to participate in the investment decision.

For example, many organizations in the present business environment are dealing with questions related to security. Many kinds of security decisions are possible such as the array of products and services that can be purchased. The organization must also identify questions such as its security needs and budget. Finally, decisions related to prioritization of investment options must be made.

The method and system of the present invention provides a structured manner of addressing, shaping, quantifying, and making such business decisions. The process in part provides a decision-making framework. Data is inputted from multiple functionalities related selected issues. Data may then be quantified. The data may then be submitted for peer review and revision. The result of the steps of the process is a decision-making structure that allows a prioritizing of multiple options to meet multiple needs on a defined budget.

While the present invention deals specifically with an automated methodology, system and product for providing business solutions via the provision of an inventive process flow, it is contemplated herein that such inventive techniques are readily applied to the investment decision-making process of any firm and of any type of corporate environment.

### SUMMARY OF THE INVENTION

The invention is a process, methodology, and system for developing a business case to justify corporate or business investments individually and in the context of competing investments. The methodology embedded in the system captures and quantifies data on strategic alignment, costs, benefits, qualitative value and business and technical risks in a way that does not currently exist. It produces a business case analysis document that presents the data inputted in a meaningful way. The system provides the ability to perform risk mitigation activities to be used as part of risk management process. The system provides the ability for cross functional reviews, a type of peer review and validation, of business cases to take place electronically. The method captures the results of the review and provides a cumulative review score. The method thereby provides transparency in the decision making process.

It is an object of the present invention to provide the ability to create unique portfolios of investments. The business case system is able to prioritize investments based on a degree of strategic alignment, financial metrics, qualitative value, business and technical risks, total value and total risk scores and cross functional review scores.

It is a further object of the present invention to allocate capital and expense budgets based on maximizing selected criteria such as strategic alignment, financial value or risk.

An additional object of the present invention is to provide a method of storing a historical record of business case analysis versions.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claim. It is to be understood that both the foregoing general description and the following detailed description are exemplary and explanatory only and are not restrictive of the invention, as claimed. Thus, the present invention comprises a combination of features, steps, and advantages which enable it to overcome various deficiencies of the prior art. The various characteristics described above, as well as other features, will be readily apparent to those skilled in the art upon reading the following detailed description of the preferred embodiments of the invention, and by referring to the accompanying drawings.

### BRIEF DESCRIPTION OF THE DRAWINGS

For a more detailed description of a preferred embodiment of the present invention, reference will now be made to the accompanying drawings, which form a part of the specification, and wherein:

FIG. 1 is a flowchart showing the steps in the creation of a business case.

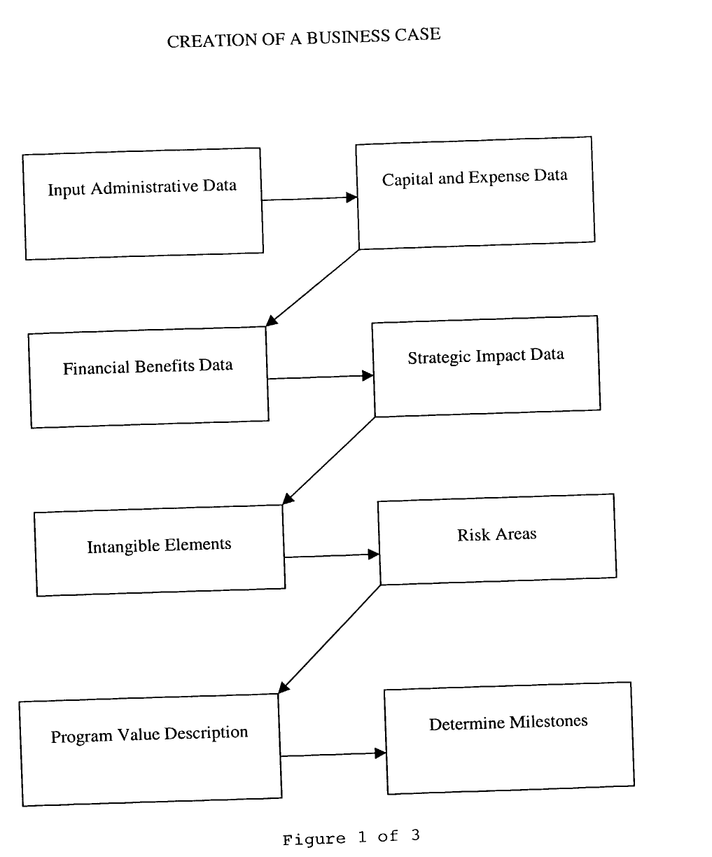

FIG. 2 is a schematic diagram showing the input options a user encounters upon first accessing the business case system.

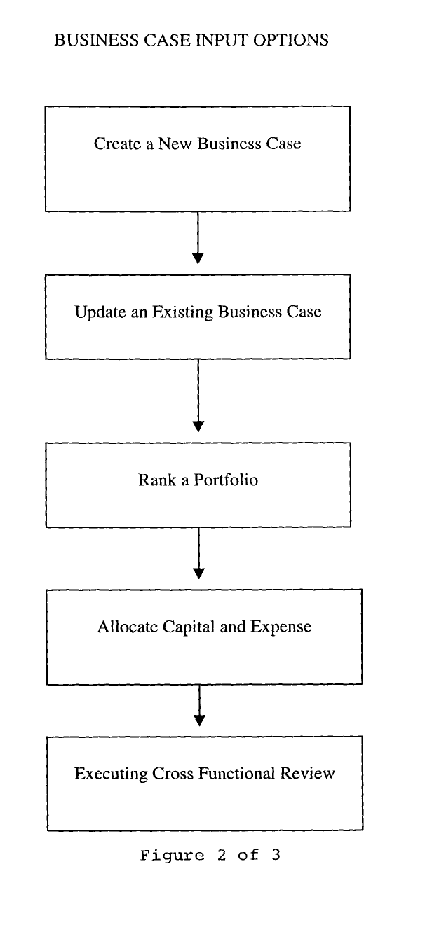

FIG. 3 is a flowchart showing the steps that occur with respect to a business case after the business case has been created.

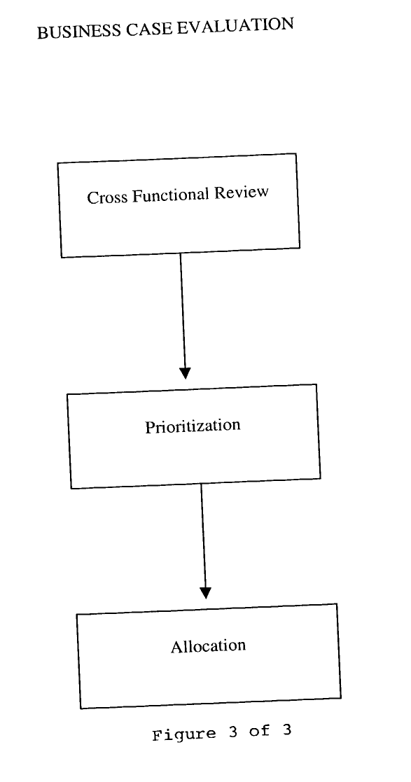

### DETAILED DESCRIPTION OF THE PREFERRED EMBODIMENT

The system and method of the present invention, in the context of a large governmental or private organization, is preferably realized through the use of commercially available computer networks. In such a network the multiple users will access and input data through known software products that may include word processing and numerical calculations, including statistical analysis. Such systems include wide area networks and local area networks, and are known to persons skilled in the art.

The present invention may further be structured so that participants in building or evaluating a business case may be entirely from within a single organization, or, may extend to other participants outside the organization. For example, vendors and suppliers from outside the host organization may contribute to the business case system.

To begin, user accesses the business case system. The log on to the business case system is completed using an assigned logon ID and password. The password is reset when it is first used to maintain user security. Multiple levels of security are provided to protect access to sensitive data.

The user has several options upon first entering the business case system. They are, create a new business case, update an existing business case, rank a portfolio or functional area business cases, allocate capital and expense funds against business case elements by portfolio or functional area, assign, complete or manage a cross functional review of one or many business cases.

The modules, users and data elements may be changed, added to or deleted in an additional systems administration area.

When a user creates a new business case, they are required to progress through several steps. Each step requires data to be input into the system. The data is entered over the course of several screens. The number of screens that need to be completed depend on the type of responses given or selected on previous screens.

Step 1 requires administrative data about the prospective investment to be entered. This data includes but is not limited to name, finance number, sponsor, program manager, phone numbers, lifecycle phase, time frame, stakeholders, dependencies and a narrative description of the scope and objective of the project.

Step 2 requires data on capital and expense funds to be expended by fiscal year for as many fiscal years as needed to complete the investment.

Step 3 requires data on the financial benefits to be gained from the investment for a maximum of ten years after the investment period. A distinction is made between a benefit that is quantifiable and provides a return to the balance sheet (Hard ROI such as new revenue or cost savings) and one that is quantifiable but does not affect the balance sheet (soft ROI such as productivity and efficiency improvements). A narative description of how the benefit was calculated, the assumptions, formulas and data used in deriving that benefit stream is also provided to substantiate the calculations and validity of the benefit. These sections are validated later in the process via the web through an electronic cross functional review process that captures data on the perceived validity of the data inputs.

Step 4 captures data on the degree of strategic impact a particular program has on an organization or unit level strategy. The impact is quantified by requiring the user to select Direct Impact, Indirect Impact or No impact when comparing the proposed investment to the organizational or functional area goals. Direct Impact is a quantifiable impact that has a direct relationship to the strategic goal. Indirect impact may or may not be quantifiable and has an indirect relationship to the strategic goal. For example, if there is a strategic goal on improving employee safety and the investment opportunity is to fund a program on safety education (e.g. with specific measurements of the amount of time, degree of exposure, specific safety practices), this would be considered a direct impact to the strategic goal. If an investment opportunity is to fund the publication of a manual and handbook of which safety is one type of publication, then the relationship is indirect.

Step 5 captures data on the degree of impact an investment opportunity has on intangible elements such as management information or competitive advantage.

Step 6 requires the user to answer questions about pre-identified risk areas. The user is asked to rate the probability of a risk occurring and the severity of the impact of the risk outcome to the success of the program. The evaluation selects a low, moderate, or high degree of risk.

Step 6 also enables the user to create a risk mitigation plan by identifying the owner, risk strategy, cost and description of how a specific risk that is rated moderate or above would be mitigated in the event it occurs.

Step 7 requires the user to enter a narrative description of the value of the program and how the program's success will be measured. An example of the narrative of this section would include how a program fulfills the mission, strategies or goals of an organization or unit, and a discussion of how the potential future value the investment opportunity adds to an organization. The success metrics of this narrative section would include what the targeted measurable goals of the investment are (e.g. increase in revenue, decrease in costs, increase in competitive advantage, or management information that leads to improved operations or revenue). The success metrics would also include what data would be used to measure progress against these goals, how often it would be reported and to whom. The description should also include assumptions that go into the measurements and what is defined to be a success. This may include description of items such as a break-even point, a minimum number of hours or cost reduced, and an increase in throughput above a baseline.

Step 8 requires determining the maximum number of milestones in each fiscal year and providing summary information on each milestone including a brief description, the lifecycle phase, the start and end dates and comments on the deliverable or milestone.

The user is then presented with an option to either revise the inputs or print the inputs in document form. The document includes all the data inputs and the result of calculations of the inputs in numerical and language form.

At this point the creation of a business case is completed. The next phase of the process includes submitting the business case for review, modification or revision of the business case, and decision making. If approved, the business case is concluded with an allocation of funds.

Versioning—After completing the first version of a business case, a user is able to continuously update the business case as new information becomes available and as the investment opportunity progresses. Cross function review, for example, may call for additional versions of the program.

Cross Functional Reviews—The completed business case is then able to be assigned to either random or specific reviewers to rate the degree of agreement with the validity of the data inputted by the user who created a specific business case. The degree of concurrence scores prioritization.

Prioritization—In step 1, the user selected a functional area and portfolio that the investment would be associated with. All other investment opportunities that have selected the same functional area or portfolio are grouped together. These groupings enable all the proposed investments to be ranked according to the numerical scores in strategic alignment, financial value, and qualitative value, risk, and cross functional review scores.

Allocation—the business case system also enables the allocation of a five-year capital and expense budget for the same grouping of portfolios or functional areas. The allocation is based on a selected business case element such as strategic alignment, return on investment, or risk. The tool ranks the investment opportunities against the selected criteria and determines which opportunities may be funded given the budget parameters.

Quantification and Data Scoring—The business case captures two types of data. The first is narrative that provides information specific to an investment opportunity. A second is data that is captured through a series of questions and answers in multiple modules or sections of the system. In the latter form of data captured, each question and answer is assigned a numerical weight. The numerical weights are initially based on experimental data and are confirmed through statistical analysis. The management of the organization making investment decisions in order to reflect their priorities and values may also set the weights. The weights to each module, question, and answer are stored in a database table. As a user progresses through the creation or revision of a business case, the selection of answers to questions calculates a score to each question and each module. The calculations occur in real time as the user progresses through the steps provided by the system to complete a new or revised business case. These calculations are then consolidated into scores for each module that are reported on the business case analysis output document. Multiple business cases are then enabled to be prioritized based on quantified, peer-reviewed data. In this manner, numerous business cases are able to be compared on a like basis using the same criteria and weights in order to enable allocation of limited capital and expense funds as the data is being entered. The results obtained are saved and may be updated as the new information becomes available.

In operation the data that constitutes a business case is inputted by one or several different individuals within an organization. The information related to that business case is made available to others within the organization. Those who are stakeholders, who would be impacted by the decision, who control the budget, who decide whether to execute an investment, and who provide data related to the potential investment, are all individuals who would have access to the business case. The method of access is preferably computer based access through a network. Memory for data storage is provided through some suitable storage means. Likewise, preferably, a common software is used for individuals to access the business case.

While preferred embodiments of this invention have been shown and described, modifications thereof can be made by one skilled in the art without departing from the spirit or teaching of this invention. The embodiments described herein are exemplary only and are not limiting. Many variations and modifications of the system and apparatus are possible and are within the scope of the invention. One of ordinary skill in the art will recognize that the process just described may easily have steps added, taken away, or modified without departing from the principles of the present invention. Accordingly, the scope of protection is not limited to the embodiments described herein, but is only limited by the claims which follow, the scope of which shall include all equivalents of the subject matter of the claims.

What is claimed is:

1. A process for providing solutions for business decisions by inputting relevant data into a software application and commanding the software to deliver results appropriate to the selected criteria comprising the following steps of inputting the data in the respective fields on a computer screen:
administrative data about the prospective investment;
selected data on capital and expense funds to be expended by fiscal year for as many fiscal years as needed to complete the investment;
financial benefits to be gained from the investment for a maximum of ten years after the investment year;
the degree of strategic alignment impact a particular program has on an organization or unity level strategy;
the degree of impact an investment opportunity has on intangivle elements such as management information;
select from a group of alternatives the extent of risk;
a narrative description of the value of the program;
the maximum number of milestones in each fiscal year and providing a summary for each milestone;
revising if necessary the entered data displayed;
conducting peer review;
prioritizing investments; and
allocating limited capital and expense financial resources while maximizing the result of a specific value or risk criteria.

2. The process of claim 1 wherein said alternative extent of risk includes low, medium, and high.

3. The process of claim 1 further comprising a risk mitigation plan.

4. The process of claim 1 further comprising a definition for measurement of success.

5. The process of claim 1 wherein said administrative data comprises name, finance number, sponsor, program manager, phone number, lifecycle phase, time frame, stakeholders, dependencies, and a narrative description of the scope and objective of the project.

6. The process of claim 1 wherein said prioritizing step is done without regard to the amount of investment based on quantified value and risk data.

7. An automated method for evaluating business investment options comprising first options of:
creating a new business case;
updating an existing business case;
ranking a portfolio or functional area business cases;
allocating capital and expense funds against business case elements by portfolio or functional area; and
assigning completing or managing a cross functional review of one or many business cases.

8. An automated method for evaluating investment options within an organization with multiple data providers, comprising the steps of:
inputting administrative data about the prospective investment;
inputting data on capital and expense funds to be expended by fiscal year;
inputting data on the financial benefits to be gained from the investment;
capturing data on the degree of strategic impact a particular program has on an organization or unit level strategy;
capturing data on the degree of impact an investment opportunity has on intangible elements;
answering questions related to pre-identified risk areas;
providing a narrative description of the value of the program; and
determining the maximum number of milestones.

9. The method of claim 8 further comprising updating a business case to a new version.

10. The method of claim 8 further comprising submitting a proposed business case to cross-functional review.

11. The method of claim 8 further comprising prioritizing business opportunities.

12. The method of claim 8 further comprising allocating capital and expense budgets.

13. The method of claim 8 further comprising quantifying data and scoring data.

14. The method of claim 8 wherein said strategic impact may comprise a direct impact, and indirect impact, or no impact.

15. The method of claim 8 wherein the financial benefits include both benefits that provide a return on a balance sheet and do not affect a balance sheet.

16. The method of claim 8 wherein said intangible elements include management information and competitive advantage.

17. The method of claim 8 further comprising creating a risk mitigation plan.
